(19) United States
(12) Patent Application Publication
(10) Pub. No.: US 2006/0164827 A1
(43) Pub. Date: Jul. 27, 2006

(54) Portable sign illuminator

(76) Inventors: Hugh T. Minewiser, Cedar Park, TX (US); Rex F. Arseculeratne, Round Rock, TX (US)

Correspondence Address: Michael A. Ervin, 8202 Talbot Cove, Austin, TX, 78746, US

(21) Appl. No.: 11/044,134

(22) Filed: Jan. 27, 2005

(51) Int. Cl. F21L 4/00

(52) U.S. Cl. 362/183; 362/812; 362/159

(57) ABSTRACT

A portable sign illumination system that can provide its own power for illumination, based on solar panels, is light in weight, easy to install, and can be locked onto the sign frame. It can fit sign frames that are presently on the market, and be easily modified to fit many other sign frames. The system employs a light reflecting system to direct light onto the sign.

### TECHNICAL FIELD

The present invention generally relates to lighting and display devices and more particularly to a realty sign lighting and display assembly.

### BACKGROUND

The widespread use of signage in the outdoors marketing of goods is often hampered in its effectiveness by a lack of proper illumination. An important example is residential real estate signage. It is important in the selling and renting of realty that proper advertising is strategically placed adjacent the property to be rented or sold. In many cases it becomes difficult to light such signs at night, because of an absence of a convenient close by power source. Although solar panels have in a few instances been relied on as a source of lighting power for such devices and structures as outdoor phone booths and the like, such assemblies are usually of the permanent type, portability not being contemplated. In the case of realty signs, however, portability is essential, since such signs are moved around from one house or building to the next as they are each in turn rented or sold.

Such signs are most effective when they are lighted at night, since many people drive by at night to look at residences and business property they are interested in, evening hours being convenient for the prospective purchasers and buyers. Such properties are easy to locate with lighted signs, which also help to attract the attention of casual drivers by.

U.S. Pat. No. 5,101,329 to Doyle describes one approach to such a sign illumination system, adapted particularly to a real estate standard having one vertical post and a horizontal arm. The design incorporates an electrical storage battery charged by a solar panel in a housing that fits over the particular horizontal arm of such a sign system.

U.S. Pat. No. 6,004,002 to Gianonne describes a design for illuminating a convention realty sign frame utilizing a solar panel with a repositionable array of cells, an electrical storage battery, and an illumination unit containing lamps and reflectors and attachment devices for connection to a variety of signs.

These prior art devices address some of the needs referred to before but are costly, and too large and cumbersome for the typical small frame signs often used in for example realty signage.

There is therefore a need for a portable device that can provide its own power for illumination, is light in weight, easy to install, and can be locked onto the sign frame. It should be able to fit sign frames that are presently on the market, and be easily modified to fit many other sign frames. The device should be inexpensive, reliable, and easy to store when not in use.

### SUMMARY

The needs discussed are addressed by the instant invention.

To insure that a clear and complete explanation is given to enable a person of ordinary skill in the art to practice the invention specific examples will be given involving applying the invention to a specific configuration of a commercial sign. It should be understood though that the inventive concept could apply to various modifications of such signage systems and the specific examples are not intended to limit the inventive concept to the example application.

### BRIEF DESCRIPTION OF THE DRAWINGS

FIG. 1 a cutaway isometric view of a preferred embodiment of the instant invention.

FIG. 2 is an isometric view of two common real estate sign frames.

FIG. 3 is two isometric views of the complete illuminator reflector assembly.

FIG. 4 is an isometric view of the complete portable sign illumination system after mounting on a sign frame.

FIG. 5 is an expanded isometric rendering of a mounting mechanism.

FIG. 6 is a front-end view of a mounting mechanism.

FIG. 7 is a front-end view of a mounting mechanism.

FIG. 8 is a cutaway isometric rendering showing a locking mechanism.

FIG. 9 is an end view of the portable sign illuminator reflector operation.

FIG. 10 is an end view of the portable sign illuminator reflector operation.

### DETAILED DESCRIPTION

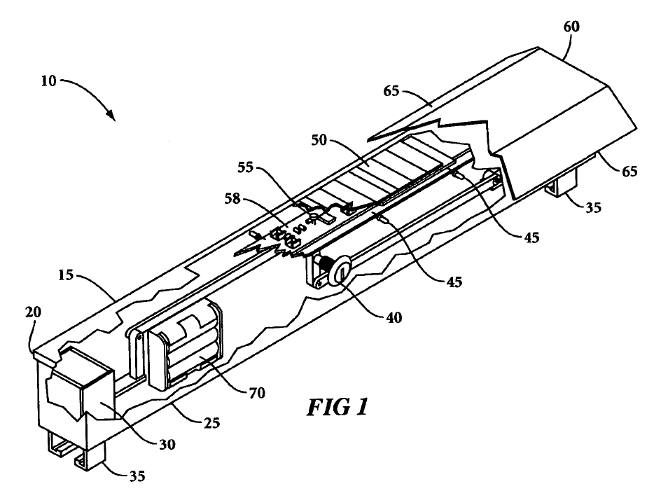

FIG. 1 is a cutaway isometric view of a preferred embodiment of the instant invention, shown generally by the numeral 10. The portable sign illumination system is enclosed in a housing, shown generally by the numeral 15, which has a bottom enclosure 25 and cover 20. Shown near the end of the housing is a mounting mechanism 30 with mounting tab 35 beneath. A second mounting mechanism with a mounting tab 35 can be seen at the opposite end of the housing. A locking mechanism 40 near the center of the housing operates to lock the mounting mechanisms in place. Light devices 45, in this case high intensity light emitting diodes, are shown that provide illumination, and are powered by rechargeable battery 70. As many light devices as needed to provide illumination will be supplied. For signs of the size of most realty signs about six high intensity light emitting diodes per side are usually sufficient. Solar cells 50, for charging of rechargeable batteries 70, are mounted on the top cover 20 of housing 15. A light sensitive photocell 55 is provided to control an electronic circuit 58 to turn lights 45 on in low light and off in high light conditions. A reflector mechanism cover 60, mounted over housing 15, has reflectors 65 that are pivoted to extend out at an angle and reflect light from light devices 45 down onto the sign.

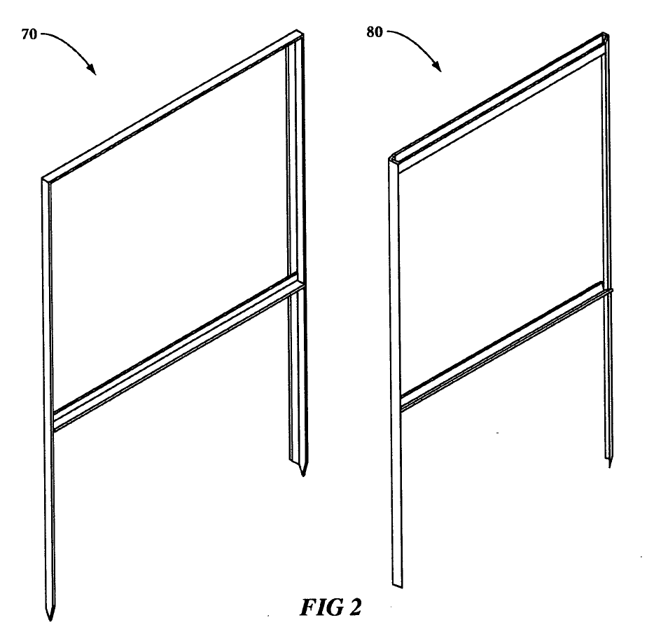

FIG. 2 exhibits two of the most common real estate type sign frames, shown as 70 and 80. These types of sign frames are widely used because they allow easy change out of signs, which slide easily into or bolt onto the frame. Although these two types are very common, the mounting mechanism of the instant invention can accommodate many related versions.

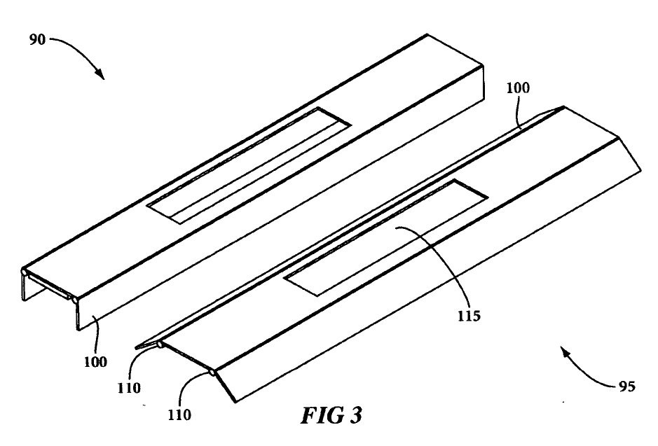

FIG. 3 shows two isometric views of the complete illuminator reflector assembly. View 90 shows the illuminator reflector with the reflectors 100 in the closed position. View 95 is with the reflectors 100 in the open and working position. The reflectors 100 pivot on hinges 110. Open area 115 is a cutout to provide an opening for the solar panel and photocell. The electrical output of the solar panel is sufficient to recharge the batteries during the day. Inside the housing, with access only when the unit is not mounted on a sign frame, are the replaceable rechargeable batteries. Also, an electronic circuit, controlled by the photocell, provides control of the LEDs.

FIG. 4, represented generally by the numeral 120 is an isometric view of the complete portable sign illumination system after mounting on a conventional sign frame 125.

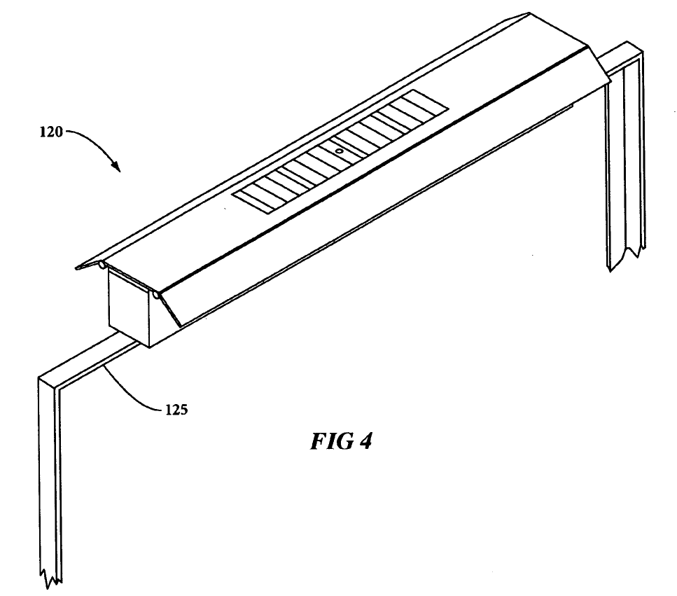

FIG. 5 is an expanded isometric rendering of the mounting mechanism, shown generally as the numeral 130. Mounting tabs 135 have a bottom lip 140 shaped to grip around the top rail of most standard sign frames. The top section 145 of the mounting tab fits within housing 150 and in contact with toothed surface 155 when the mechanism is locked.

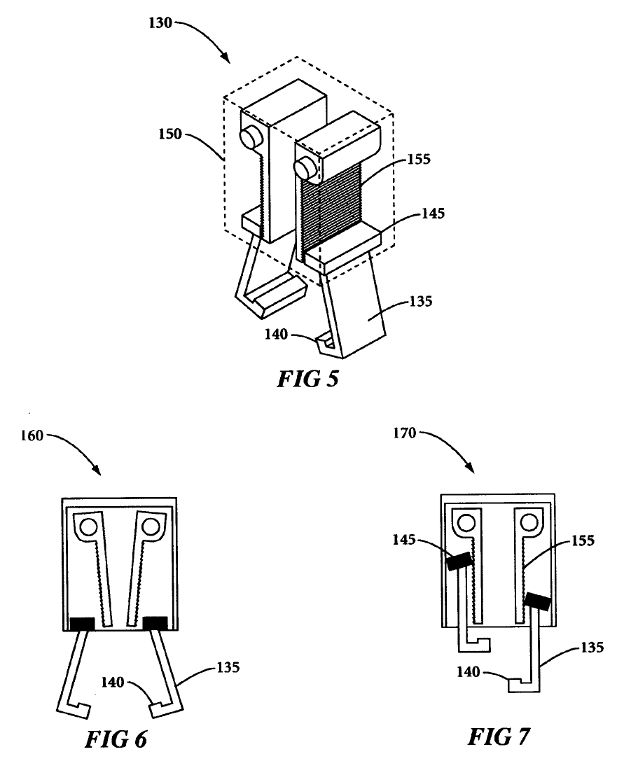

Referring now to FIG. 6, a front-end view of the mounting mechanism of FIG. 5, is shown generally by the numeral 160. The mounting mechanism and tabs are shown in the unlocked position, before being coupled to a sign frame.

In FIG. 7, the same mounting mechanism, shown generally as numeral 170 is now shown in the locked position. As the mounting mechanism is moved into place and pushed onto the sign frame the mounting tabs slide up into the mounting mechanism and the top section 145 acts as a pawl in a pawl-ratchet system. If moved downward the pawl engages the teeth of toothed surface 155 and locks into place.

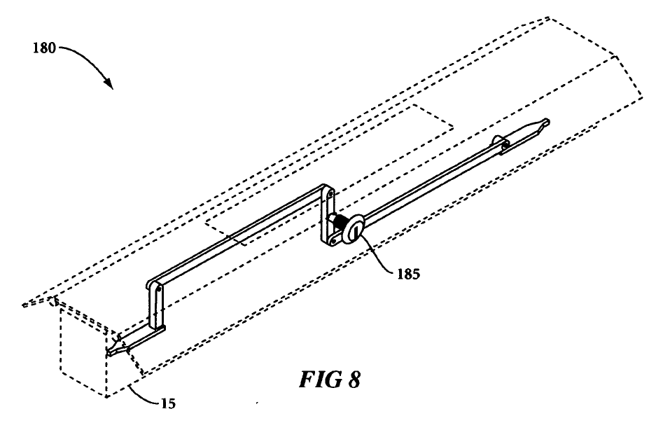

FIG. 8, shown generally by the numeral 180, is a cutaway isometric rendering showing the locking mechanism of the portable sign illumination system situated within housing 15. Locking control 185, when turned engages or dis-engages the lock. When the lock is in the locked position, the clamps are held in place and can be further tightened, but not released.

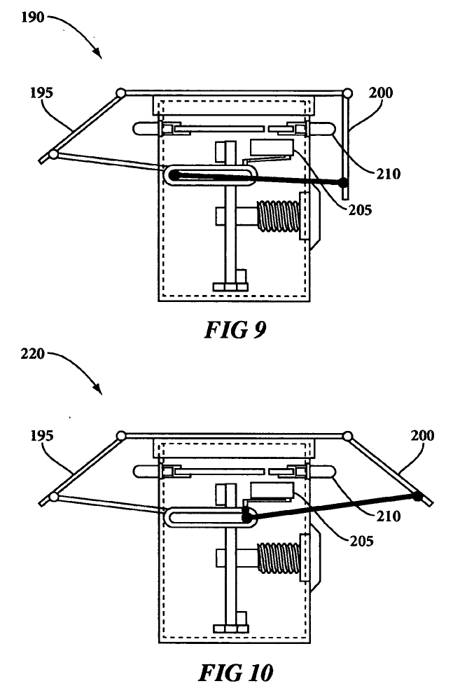

FIG. 9, shown generally as numeral 190, is an end view of the portable sign illuminator reflector operation. Reflector 195 is in the open position, reflector 200 in closed position. With reflector 200 in closed position light switch 205 is open and therefore light 210 receives no power.

FIG. 10, shown generally as numeral 220, is a similar end view as FIG. 9 but reflector 200 is now moved to the operating position, closing switch 205 and providing power to light 210. This control scheme ensures that there is no power drain during transport and storage of the portable sign illumination system.

The reflector assembly provides three functions: 1) in the closed position, with both sides folded down against the sides of the housing, the unit is ready for transportation or storage. This position protects the LEDs, and provides protection for the reflector so that it is not easily bent out of shape. 2) In the open position, with both sides raised, the LEDs can illuminate both sides of the sign by reflecting off of the white surfaces. 3) If either side is in the closed position, the LEDs on that side do not operate. This conserves battery power when only one side of the sign is to be seen. If both sides are in the closed position, all battery power is disconnected from the unit to conserve power when the unit is being transported or stored.

Within the housing are the mounting and locking mechanisms. The mounting tabs shown are for use with two standard rectangular sign frames presently in use in the real estate market. For other signs the mounting tabs can be changed out. When the key is in the unlocked position, the tabs can be moved side-to-side and in and out of the housing. This allows the unit to be placed over the sign frame. When the key is in the locked position, the tabs can only be moved into the housing. The tabs can be differently shaped for other sign frames, and the mounting can be used not only on the top but also on the sides, or upside down on the bottom of the frame.

While one (or more) embodiment(s) of this invention has (have) been illustrated in the accompanying drawings and described above, it will be evident to those skilled in the art that changes and modifications may be made therein without departing from the essence of this invention. All such modifications or variations are believed to be within the sphere and scope of the invention as defined by the claims appended hereto.

1. A portable sign illumination system, comprising:
a. a housing with at least one mounting mechanism for attaching to a sign frame;
b. a locking mechanism to lock said mounting mechanism to said sign frame;
c. a solar panel incorporated into said housing;
d. a rechargeable battery connected to said solar panel;
e. at least one light connected to said housing and said rechargeable battery; and
f. a reflector mounted on at least one side of said housing.

2. The portable sign illumination system of claim 1 wherein said at least one light is a high intensity light emitting diode.

3. The portable sign illumination system of claim 1 wherein said reflector is movably connected to a hinge to pivot between a closed position and an open position.

4. The portable sign illumination system of claim 3 wherein said at least one light receives power from said rechargeable battery only when said reflector is in said open position.

5. The portable sign illumination system of claim 1 wherein said mounting mechanism further comprises at least one mounting tab for mounting to said sign frame.

6. The portable sign illumination system of claim 5 wherein said at least one mounting tab further comprises a lip for gripping a rail of said sign frame.

7. The portable sign illumination system of claim 5 wherein said mounting tab locks into place by engaging the teeth of a ratchet-pawl system.
